(19) United States
(12) Patent Application Publication
(10) Pub. No.: US 2023/0205602 A1
(43) Pub. Date: Jun. 29, 2023

(54) PRIORITY INVERSION MITIGATION

(71) Applicant: ADVANCED MICRO DEVICES, INC., Santa Clara, CA (US)

(72) Inventors: Yash UKIDAVE, Santa Clara, CA (US); Randy Ramsey, Santa Clara, CA (US); Nishank Pathak, Santa Clara, CA (US); Baturay Turkmen, Santa Clara, CA (US)

(21) Appl. No.: 17/564,074

(22) Filed: Dec. 28, 2021

(51) Int. Cl. G06F 9/50; G06T 1/20

(52) U.S. Cl. CPC G06F 9/5083; G06F 9/5038; G06F 9/5044; G06F 9/5016; G06T 1/20

(57) ABSTRACT

Parallel processors typically allocate resources to workloads based on workload priority. Priority inversion of resource allocation between workloads of different priorities reduces the operating efficiency of a parallel processor in some cases. A parallel processor mitigates priority inversion by soft-locking resources to prevent their allocation for the processing of lower priority workloads. Soft-locking is enabled responsive to a soft-lock condition, such as one or more priority inversion heuristics exceeding corresponding thresholds or multiple failed allocations of higher priority workloads within a time period. In some cases, priority inversion heuristics include quantities of higher priority workloads and lower priority workloads that are in-flight or incoming, ratios between such quantities, quantities of render targets, or a combination of these. The soft-lock is released responsive to expiry of a soft-lock timer or incoming or in-flight higher priority workloads falling below a threshold, for example.

### BACKGROUND

Processing systems often include a parallel processor to process graphics (i.e., by processing graphics workloads) and to perform video processing operations, machine learning operations, and so forth (i.e., by processing asynchronous compute workloads). In order to efficiently execute such operations, the parallel processor divides the operations into threads and groups of similar threads, such as similar operations on a vector or array of data, into sets of threads referred to as wavefronts. The parallel processor executes the threads of one or more wavefronts in parallel at different compute units of the parallel processor.

A graphics processing unit (GPU) is an example of a parallel processor that typically processes three-dimensional (3-D) graphics using a graphics pipeline formed of a sequence of programmable shaders and fixed-function hardware blocks. Shaders are categorized into various shader types, such as geometry shaders, vertex shaders, and pixel shaders. Different graphics workloads typically require different shader types for processing, and compute resources are allocated to implement each shader type based on that shader type's priority. Processing efficiency of the parallel processor is enhanced by increasing the number of wavefronts that are executing or ready to be executed at the compute units at a given point in time. Typically, asynchronous compute workloads are given higher priority than graphics workloads. Priority inversion occurs when compute resources of a parallel processor are allocated for processing a lower priority workload, such as a graphics workload, instead of being allocated for processing a higher priority workload, such as an asynchronous compute workload, that is ready to be processed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a parallel processor configured to perform priority inversion mitigation, in accordance with some embodiments.

FIG. 2 is a block diagram of a graphics pipeline that utilizes resources of a unified shader pool to implement shaders of various types, with allocation of the resources being managed by a resource allocator, in accordance with some embodiments.

FIG. 3 is a block diagram of a portion of a parallel processor showing priority inversion heuristics calculated by a resource allocator, based on which a soft-lock signal is selectively enabled to mitigate priority inversion, in accordance with some embodiments.

FIG. 4 is a flow diagram illustrating a method for priority inversion mitigation in a parallel processor using priority inversion heuristics, in accordance with some embodiments.

FIG. 5 is a flow diagram illustrating a method for selectively enabling a soft-lock for computing resources to prevent allocation to lower priority workloads based on priority inversion heuristics, in accordance with some embodiments.

FIG. 6 is a flow diagram illustrating a method for selectively enabling a soft-lock for computing resources to prevent allocation of resources to graphics workloads responsive to detecting a priority inversion, in accordance with some embodiments.

### DETAILED DESCRIPTION

In the context of computer processing, a priority inversion is considered to have occurred whenever a lower priority workload is scheduled for execution and/or resources are allocated for execution of such a lower priority workload, and this scheduling/allocation delays execution of a higher priority workload that is otherwise ready for execution. For example, in parallel processors such as graphics processing units (GPUs), priority inversion occurs between higher priority graphics workloads (e.g., geometry shaders, vertex shaders) and lower priority graphics workloads (e.g., pixel shaders). This type of priority inversion sometimes occurs due to resource allocation in the parallel processor allowing resource allocation requests of smaller sizes, such as those typically associated with pixel workloads, to be successfully allocated ahead of resource allocation requests of larger sizes, such as those typically associated with geometry workloads, since it is easier to find a “fit” for smaller resource allocation requests. This behavior has the potential to continuously block resource allocation requests of larger sizes, leading to lower priority pixel workloads continuously winning resource allocation over higher priority geometry workloads, for example, resulting in prolonged priority inversion. As another example, in GPUs that process asynchronous compute workloads in parallel with graphics workloads, priority inversion can occur between asynchronous compute workloads and graphics workloads (with asynchronous compute workloads typically being assigned higher priority in the GPU, though not in all cases). In either example, prolonged priority inversion can result in an undesirable backlog of higher priority work, which can reduce the efficiency with which the parallel processor operates. For example, by allowing a backlog of geometry workloads to accumulate, generation of corresponding pixel workloads is delayed, resulting in periods of time when no pixel workloads are available to be processed, which prevents the parallel processor from operating at its full pixel-rate.

Embodiments of parallel processors and corresponding techniques described herein detect instances of priority inversion between higher priority and lower priority workloads, and responsively mitigate such priority inversion by temporarily preventing compute resources from being allocated to the lower priority workloads (sometimes referred to herein as enabling or activating a “soft-lock” of compute resources for the lower priority workloads). In some embodiments, a resource allocator of a parallel processor calculates one or more priority inversion heuristics (e.g., data indicative of whether priority inversion is likely), and selectively soft-locks allocation of compute resources for lower priority workloads based on the priority inversion heuristics (e.g., based on comparisons of the priority inversion heuristics to associated thresholds). In some embodiments, in response to a priority inversion event in which the resource allocator fails to allocate resources for processing the higher priority workload (e.g., due to unavailability of the required compute resources), and in which the resource allocator successfully allocates compute resources to a lower priority workload, the resource allocator initiates a failed allocation timer, which is configured to expire at the end of a given time period. If the higher priority workload fails allocation (i.e., no compute resources are allocated to the higher priority workload) before expiry of the failed allocation timer, then the resource allocator enables the soft-lock to prevent all or a portion of the compute resources of the parallel processor from being allocated to lower priority workloads. In some embodiments, the soft-lock is disabled when one or more soft-lock release conditions are met. Such soft-lock release conditions include, for example, expiration of a soft-lock time period, a system reset, or one or more priority inversion heuristics falling below a corresponding threshold. By selectively soft-locking compute resources from being allocated to lower priority workloads in response to indications of priority inversion, the resource allocator prevents an accumulation of a backlog of higher priority workloads, thereby mitigating the impact of priority inversion on operational efficiency of the parallel processor.

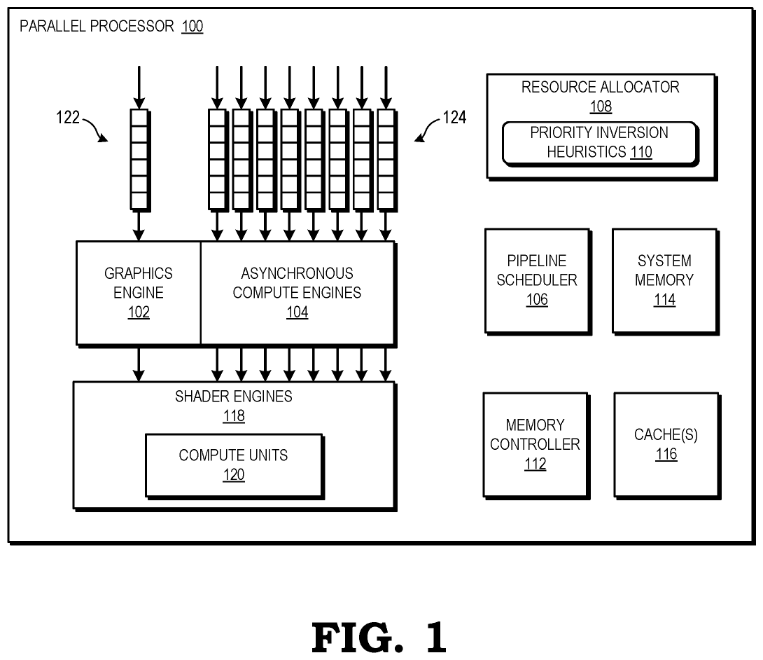

FIG. 1 illustrates a parallel processor 100 that is configured to detect and mitigate occurrences of priority inversion between lower and higher priority workloads. In some embodiments, the higher priority workloads correspond to graphics workloads that require allocation of higher priority shaders, such as geometry shaders or vertex shaders (such workloads being sometimes referred to herein as “geometry workloads”), and lower priority workloads correspond to graphics workloads that require allocation of lower priority shaders such as pixel shaders (such workloads being sometimes referred to herein as “pixel workloads”). In some embodiments, the higher priority workloads are asynchronous compute workloads and the lower priority workloads are graphics workloads.

As shown, the parallel processor 100 includes a graphics engine 102, asynchronous compute engines (ACEs) 104, a pipeline scheduler 106, a resource allocator 108 configured to calculate priority inversion heuristics 110, a memory controller 112, a system memory 114, one or more caches 116, and shader engines 118 that include compute units 120. Commands received by the parallel processor 100 (received, for example, from a host processor coupled to the parallel processor 100) are stored in queues 122 and 124 to await processing by the graphics engine 102 (in the case of the queue 122) and the ACEs 104 (in the case of the queues 124). Herein, the queue 122 is sometimes referred to as a “graphics queue” and the queues 124 are sometimes referred to as “asynchronous compute queues”. The commands stored at the queues 122 and 124 are typically commands related to rendering an image, such as a three-dimensional (3D) image of a scene. In some embodiments, the queues 122 and 124 each include one or more first-in-first-out buffers.

The shader engines 118 are implemented using shared hardware resources of the parallel processor 100, such as compute units 120. In some embodiments, the shader engines 118 are used to implement shaders, such as geometry shaders, pixel shaders, and the like. The resource allocator 108 is configured to allocate shared resources, including compute resources such as the compute units 120 of the shader engines 118, for processing workloads (e.g., for implementing shaders of various types in connection with processing workloads). In some embodiments, the resource allocator 108 periodically determines how available shared resources are to be allocated for the execution of one or more workloads during an allocation period and allocates the resources to process those workloads. The graphics engine 102 is configured to execute graphics workloads, sometimes involving the implementation of geometry shaders or pixel shaders, for example. The ACEs 104 are configured for executing compute workloads (sometimes referred to herein as “asynchronous compute workloads), sometimes involving the implementation of compute shaders, for example. The ACEs 104 are distinct functional hardware blocks that are each capable of executing compute workloads concurrently with execution of other compute workloads by other ACEs of the ACEs 104 and with processing of graphics workloads by the graphics engine 102. That is, the graphics engine 102 is capable of processing graphics workloads in parallel with the processing of asynchronous compute workloads by the ACEs 104, and the ACEs 104 are collectively capable of parallel processing of multiple asynchronous compute workloads.

The pipeline scheduler 106 is configured to schedule commands for execution by the graphics engine 102, the ACEs 104, and compute resources (e.g., compute units 120 of the shader engines 118) allocated by the resource allocator 108. For example, the pipeline scheduler 106 is used to schedule the execution of commands when implementing a graphics pipeline, as described below.

The caches 116 include one or more caches, which in some instances are organized within a cache hierarchy. In some embodiments, the caches 116 are configured to store prefetched data (e.g., commands, context information, vertex data, texture data, and the like) from the system memory 114, for subsequent use when processing graphics workloads or asynchronous compute workloads, for example. The memory controller 112 is configured to manage fulfillment of memory access requests (issued, for example, by the graphics engine 102, ACEs 104, or shader engines 118 during processing of corresponding workloads) via communication with the caches 116, the system memory 114, or both, as identified in the memory access requests.

The resource allocator 108 is configured to calculate one or more priority inversion heuristics 110 that are indicative of priority inversion between higher priority workloads and lower priority workloads. As described above, priority inversion occurs when compute resources of a parallel processor are allocated for implementing a lower priority workload instead of being allocated for processing a higher priority workload, typically where implementation of the lower priority workload prevents allocation of compute resources for processing the higher priority workload. According to various embodiments, the priority inversion heuristics 110 include respective quantities of one or more of incoming higher priority workloads, in-flight higher priority workloads, incoming lower priority workloads, render targets (RTs) in the active workload of the in-flight workloads, or one or more ratios of lower priority workloads to higher priority workloads. For example, an “active workload” of the in-flight workloads refers to a workload that is actively being executed by the parallel processor 100. In some embodiments, the resource allocator 108 uses the priority inversion heuristics 110 to detect priority inversion between higher priority geometry workloads and lower priority pixel workloads. In some embodiments, the resource allocator 108 uses the priority inversion heuristics 110 to detect priority inversion between higher priority asynchronous compute workloads and lower priority graphics workloads. In response to detecting priority inversion based on the priority inversion heuristics 110, the resource allocator 108 selectively enables a soft-lock of one or more compute resources (e.g., the compute units 120 of the shader engines 118), which prevents allocation of the compute resources for the processing of lower priority workloads.

In some embodiments, the resource allocator 108 manages one or more failed allocation timers. For example, a given failed allocation timer is activated responsive to a failure to allocate compute resources for a higher priority workload and expires once a predetermined amount of time has passed (measured, in some instances, by counting clock cycles with the failed allocation timer). Herein, an “in-flight” workload is a workload that actively being processed (e.g., as part of a graphics pipeline), as opposed to an “incoming” workload in the queues 122 and 124 that is awaiting scheduling and allocation.

For example, if the priority inversion heuristics 110 indicate priority inversion between higher priority geometry workloads and lower priority pixel workloads, the resource allocator 108 soft-locks one or more compute resources from being allocated for processing lower priority pixel workloads until a soft-lock release condition is met. For example, if the priority inversion heuristics 110 indicate priority inversion between higher priority asynchronous compute workloads and lower priority graphics workloads, the resource allocator 108 soft-locks one or more compute resources from being allocated for processing lower priority graphics workloads until a soft-lock release condition is met. Such soft-lock release conditions include, for example, expiration of a soft-lock time period, a system reset, or one or more priority inversion heuristics falling below a corresponding threshold. By selectively soft-locking compute resources from being allocated to lower priority workloads in response to indications of priority inversion, the resource allocator 108 prevents a backlog of higher priority workloads from accumulating, thereby mitigating the impact of priority inversion on operational efficiency of the parallel processor 100. In some embodiments, the soft-lock is maintained for as long as one or more of the priority inversion heuristics 110 continues to indicate priority inversion, even if a soft-lock release condition has otherwise been met.

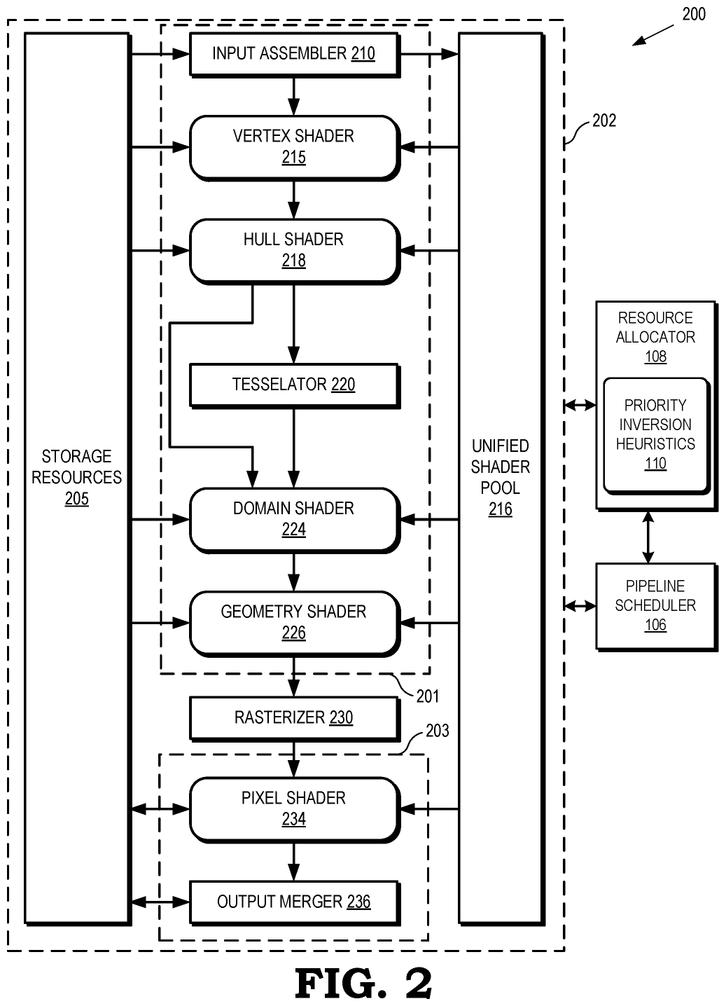

FIG. 2 depicts a block diagram of a portion 200 of a parallel processor configured to implement a graphics pipeline 202 that is capable of processing high-order geometry primitives to generate rasterized images according to some embodiments. The graphics pipeline 202 is implemented in some embodiments of the parallel processor 100 shown in FIG. 1, and like elements are referred to using like reference numerals in the present example. The graphics pipeline 202 is subdivided into a geometry processing portion 201 that includes portions of the graphics pipeline 202 prior to rasterization and a pixel processing portion 203 that includes portions of the graphics pipeline 202 subsequent to rasterization.

The graphics pipeline 202 has access to storage resources 205 (sometimes referred to herein as “storage components”) such as a hierarchy of one or more memories or caches that are used to implement buffers and store vertex data, texture data, and the like. The storage resources 205 are implemented using some embodiments of the system memory 114, shown in FIG. 1. Some embodiments of the storage resources 205 include (or have access to) one or more caches or random access memories (RAM). Portions of the graphics pipeline 202 utilize texture data stored in the storage resources 205 to generate rasterized images, such as rasterized images of 3D scenes.

An input assembler 210 accesses information from the storage resources 205 that are used to define objects that represent, for example, portions of a model of a scene. A vertex shader 215 logically receives a single vertex of a primitive (e.g., a basic shape, such as a triangle) as input and outputs a single, shaded vertex. Some embodiments of shaders such as the vertex shader 215 implement massive single-instruction-multiple-data (SIMD) processing so that multiple vertices are processed concurrently. In some embodiments, the graphics pipeline 202 implements a unified shader model so that all of the shaders included in the graphics pipeline 202 have the same execution platform on the shared massive SIMD compute units. The shaders, including the vertex shader 215, are therefore implemented using a common set of resources (e.g., compute resources) represented here as a unified shader pool 216, which includes, for example, embodiments of the compute units 120 of the shader engines 118. In some embodiments, the resource allocator 108 allocates compute resources of the unified shader pool 216 for the implementation of shaders of the graphics pipeline 202 for executing corresponding workloads (with “geometry workloads” corresponding to the geometry processing portion 201 and “pixel workloads” corresponding to the pixel processing portion 203) at times determined by the pipeline scheduler 106.

A hull shader 218 operates on input high-order patches or control points that are used to define the input patches. The hull shader 218 outputs tessellation factors and other patch data. In some embodiments, primitives generated by the hull shader 218 are provided to a tessellator 220. The tessellator 220 receives objects (such as patches) from the hull shader 218 and generates information identifying primitives corresponding to the input object, e.g., by tessellating the input objects based on tessellation factors provided to the tessellator 220 by the hull shader 218. Tessellation subdivides input higher-order primitives such as patches into a set of lower-order output primitives that represent finer levels of detail, e.g., as indicated by tessellation factors that specify the granularity of the primitives produced by the tessellation process. In this way, a model of a scene can be represented by a smaller number of higher-order primitives (to save memory or bandwidth) and additional details are added by tessellating the higher-order primitive.

A domain shader 224 inputs a domain location and (optionally) other patch data. The domain shader 224 operates on the provided information and generates a single vertex for output based on the input domain location and other information. A geometry shader 226 receives an input primitive and outputs up to four primitives that are generated by the geometry shader 226 based on the input primitive. In the illustrated embodiment, the geometry shader 226 generates the output primitives 228 based on the tessellated primitive 222.

A stream of primitives is provided to the rasterizer 230 and, in some embodiments, multiple streams of primitives are concatenated to buffers in the storage resources 205. The rasterizer 230 performs shading operations and other operations such as clipping, perspective dividing, scissoring, and viewport selection, and the like. The rasterizer 230 generates a set of pixels that are subsequently processed in the pixel processing portion 203 of the graphics pipeline 202 (as a “pixel flow”).

In the illustrated embodiment, a pixel shader 234 inputs a pixel flow (e.g., a set of pixels) and outputs zero or another pixel flow in response to the input pixel flow. An output merger block 236 performs blend, depth, stencil, or other operations on pixels received from the pixel shader 234.

Some or all the shaders in the graphics pipeline 202 perform texture mapping using texture data that is stored in the storage resources 205. For example, the pixel shader 234 can read texture data from the storage resources 205 and use the texture data to shade one or more pixels. The shaded pixels are then provided to a display for presentation to a user. In some embodiments, the resource allocator 108 prevents compute resources of the unified shader pool 216 from being allocated for the implementation of pixel shaders, such as the pixel shader 234, based on whether one or more of the priority inversion heuristics 110 indicates a priority inversion between the higher priority geometry workloads and the lower priority pixel workloads.

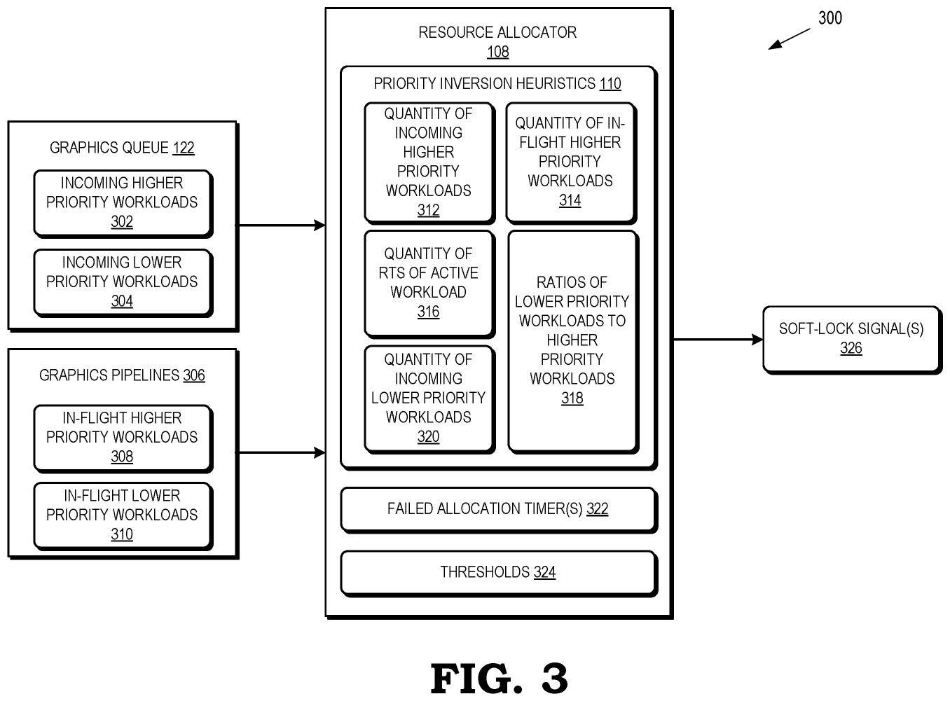

FIG. 3 shows a portion 300 of a parallel processor having a resource allocator 108 configured to calculate priority inversion heuristics and selectively soft-lock computing resources based on the priority inversion heuristics 110 to mitigate priority inversion of workloads in the parallel processor. The present example is implemented in some embodiments of the parallel processor 100 shown in FIG. 1, and like elements are referred to using like reference numerals.

As shown, the priority inversion heuristics 110 include one or more of a quantity of incoming higher priority workloads 312, a quantity of in-flight higher priority workloads 314, a quantity of RTs in an active workload of the in-flight workloads 316, one or more ratios of lower priority workloads to higher priority workloads 318, and a quantity of incoming lower priority workloads 320. In some embodiments, resource allocator 108 calculates or otherwise tracks the priority inversion heuristics 110 by, at least in part, monitoring the graphics queue 122 and one or more graphics pipelines 306. The resource allocator 108 further includes one or more failed allocation timers 322. In some cases, the resource allocator 108 determines whether priority inversion mitigation is to be enabled (e.g., whether a soft-lock of compute resources is to be enabled) based on whether one or more of the priority inversion heuristics 110 exceeds or is otherwise outside of a range defined by one or more corresponding thresholds 324.

In some embodiments, the resource allocator 108 monitors incoming higher priority workloads 302 (geometry workloads, in some embodiments) at the graphics queue 122 to calculate the quantity of incoming higher priority workloads 312. A large amount of incoming higher priority work is indicative of a backlog of higher priority work that could be made worse by priority inversion. Accordingly, the resource allocator 108 activates one or more soft-lock signals 326 responsive to determining that the quantity of incoming higher priority workloads 312 exceeds a predetermined threshold of the thresholds 324, which enables soft-locking of one or more compute resources to prevent allocation of these compute resources for processing lower priority workloads.

In some embodiments, the resource allocator 108 monitors in-flight higher priority workloads 308 being processed at the graphics pipelines 306 to determine the quantity of in-flight higher priority workloads 314. A large amount of higher priority work in-flight is indicative of a backlog of higher priority work that could be made worse by priority inversion. Accordingly, the resource allocator 108 activates one or more soft-lock signals 326 responsive to determining that the quantity of in-flight higher priority workloads 314 exceeds a predetermined threshold of the thresholds 324, which enables soft-locking of one or more compute resources to prevent allocation of these compute resources for processing lower priority workloads.

The resource allocator 108 monitors the context state of each in-flight workload to determine the number of RTs in an active workload of the in-flight workloads 316. Some graphics workloads include multiple render targets, which causes images to be rendered to multiple RT textures at once. The potential for priority inversion between higher priority geometry workloads and lower priority pixel workloads is increased when multiple RTs are being processed in the active workload. Accordingly, the resource allocator 108 activates one or more soft-lock signals 326 responsive to determining that the quantity of RTs of the active workload of the in-flight workloads 316 exceeds a predetermined threshold of the thresholds 324, which enables soft-locking of one or more compute resources to prevent allocation of these compute resources for processing lower priority workloads.

In some embodiments, the resource allocator 108 calculates one or more ratios of lower priority workloads to higher priority workloads 318 by monitoring some or all of the incoming higher priority workloads 302 and incoming lower priority workloads 304 of the graphics queue 122 and the in-flight higher priority workloads 308 and the in-flight lower priority workloads 310 of the graphics pipelines 306. According to various embodiments, such ratios include one or more of a ratio of in-flight lower priority workloads 310 to in-flight higher priority workloads 308, a ratio of incoming lower priority workloads 304 to incoming higher priority workloads 302, or a ratio of both in-flight and incoming lower priority workloads to both in-flight and incoming higher priority workloads. If the amount of incoming and/or in-flight higher priority workloads is much greater than the amount of incoming and/or in-flight lower priority workloads, priority inversion is likely. Accordingly, in response to determining that any of the ratios of lower priority workloads to higher priority workloads 318 is lower than a corresponding threshold of the thresholds 324, the resource allocator 108 activates one or more soft-lock signals 326, which enables soft-locking of one or more compute resources to prevent allocation of these compute resources for processing lower priority workloads.

In some embodiments, the resource allocator 108 activates a failed allocation timer 322 in response to a higher priority workload having failed allocation. In some embodiments, the failed allocation timer 322 is only activated if a lower priority workload is successfully allocated during the same allocation period in which the higher priority workload failed allocation since, for example, this indicates that the failed allocation of the higher priority workload was potentially contributed to by the successful allocation of the lower priority workload. The resource allocator 108 monitors the higher priority workload that triggered the activation of the failed allocation timer 322 over the time period between initiation of the failed allocation timer 322 and its expiry. If, upon expiration of the failed allocation timer, compute resources have not yet been successfully allocated to the corresponding higher priority workload, the resource allocator 108 activates one or more soft-lock signals 326, which enables soft-locking of one or more compute resources to prevent allocation of these compute resources for processing lower priority workloads. In some embodiments, an indication of whether a higher priority workload has failed allocation during a failed allocation timer period is considered a priority inversion heuristic, and the indication is included in the priority inversion heuristics 110.

In some embodiments, the resource allocator 108 monitors incoming lower priority workloads 310 being processed at the graphics pipelines 306 to determine the quantity of incoming lower priority workloads 320. A large amount of incoming lower priority work is indicative there is not an immediate need for priority inversion mitigation. For example, if priority inversion occurs while there is a large amount of incoming lower priority work, this is unlikely to negatively impact performance of the parallel processor 100, since the priority inversion would help to clear the backlog of incoming lower priority work in this case. Accordingly, in response to determining that the quantity of incoming lower priority workloads 320 exceeds a corresponding threshold of the thresholds 324, the resource allocator 108 is configured to prevent activation of the soft-lock signals 326, even if one or more other priority inversion heuristics 110 are outside of their respective threshold ranges (e.g., defined by one or more of the thresholds 324), thereby selectively preventing priority inversion mitigation via compute resource soft-locking.

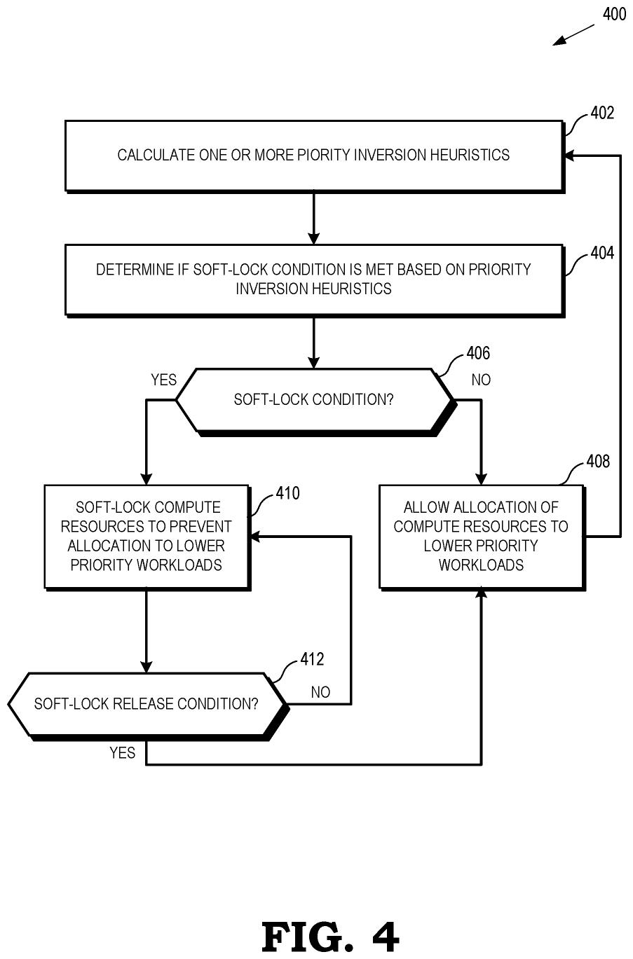

FIG. 4 shows an illustrative process flow for a method 400 of selectively controlling allocation of compute resources to lower priority workloads based on one or more priority inversion heuristics. In some embodiments, the method 400 is performed by executing computer-readable instructions at a parallel processor. In the present example, the method 400 is described in the context of an embodiment of the parallel processor 100 of FIG. 1, and like elements are referred to using like reference numerals

At block 402, the resource allocator 108 calculates or otherwise tracks one or more priority inversion heuristics 110. According to various embodiments, the priority inversion heuristics 110 include respective quantities of incoming higher priority workloads, in-flight higher priority workloads, incoming lower priority workloads, or RTs in the active workload of the in-flight workloads, or one or more ratios of lower priority workloads to higher priority workloads. In some embodiments, the resource allocator 108 manages one or more failed allocation timers, such as some embodiments of the failed allocation timer 322 of FIG. 3, as part of the priority inversion heuristics 110. For example, a given failed allocation timer is activated responsive to a failure to allocate compute resources for a higher priority workload and expires once a predetermined amount of time has passed (measured, in some instances, by counting clock cycles with the failed allocation timer).

In some embodiments, the higher priority workloads are geometry workloads and the lower priority workloads are pixel workloads. In some embodiments, the higher priority workloads are asynchronous compute workloads and the lower priority workloads are graphics workloads.

At block 404, the resource allocator 108 analyzes the priority inversion heuristics 110 to determine if a soft-lock condition has been met. For example, each of the quantities and ratios of the priority inversion heuristics 110 are compared to respective thresholds 324 by the resource allocator 108, and any quantity or ratio that is outside of its corresponding threshold range is indicative of priority inversion and, therefore, triggers a soft-lock condition.

For embodiments in which the resource allocator 108 includes a failed allocation timer 322, if the higher priority workload is not successfully allocated at any time during the time period defined by the failed allocation timer 322 (that is, prior to expiry of the failed allocation timer 322), this is indicative of priority inversion, and, therefore, triggers a soft-lock condition.

At block 406, if any soft-lock condition is triggered at block 404, the method 400 proceeds to block 410. Otherwise, if no soft-lock condition is triggered at block 404, the method 400 proceeds to block 408.

In some embodiments, the method 400 automatically proceeds to block 408, regardless of whether a soft-lock condition has been met, in the absence of a lower priority workload. For example, even if analysis of the priority inversion heuristics 110 is indicative of priority inversion, priority inversion mitigation is not performed in such embodiments if there are no queued lower priority workloads in the parallel processor.

At block 408, the resource allocator 108 allows applicable computing resources to be allocated to lower priority workloads. The method 400 then returns to block 402 to continue periodically calculating or otherwise tracking the priority inversion heuristics 110.

At block 410, the resource allocator 108 soft-locks all or a subset of computing resources of the parallel processor 100 (e.g., compute units 120 of the shader engines 118) from being allocated to lower priority workloads. In some embodiments, the resource allocator 108 activates one or more soft-lock signals (such as an embodiment of the soft-lock signals 326) to initiate the soft-lock. Soft-locking compute resources in this way mitigates priority inversion by increasing the availability of compute resources for processing higher priority workloads while the compute resources are soft-locked against allocation for lower priority workloads.

At block 412, the resource allocator 108 determines whether a soft-lock release condition has been met. According to various embodiments, such soft-lock release conditions include any of: expiry of a corresponding soft-lock timer (such that the soft-lock is only enabled for a predetermined soft-lock time period), more than a predetermined threshold (e.g., of the thresholds 324) of higher priority workloads are determined (e.g., by the resource allocator 108) to be in-flight, or if the parallel processor 100 has been reset since activation of the soft-lock. In some embodiments, the soft-lock is maintained for as long as one or more of the priority inversion heuristics 110 continues to indicate priority inversion, even if a soft-lock release condition has otherwise been met. If no soft-lock release condition is met, the method 400 returns to block 410 and the soft-lock is maintained. Otherwise, if a soft-lock release condition is met, the method 400 proceeds to block 408 at which the soft-lock is released, and associated compute resources are again allowed to be allocated for the processing of lower priority workloads.

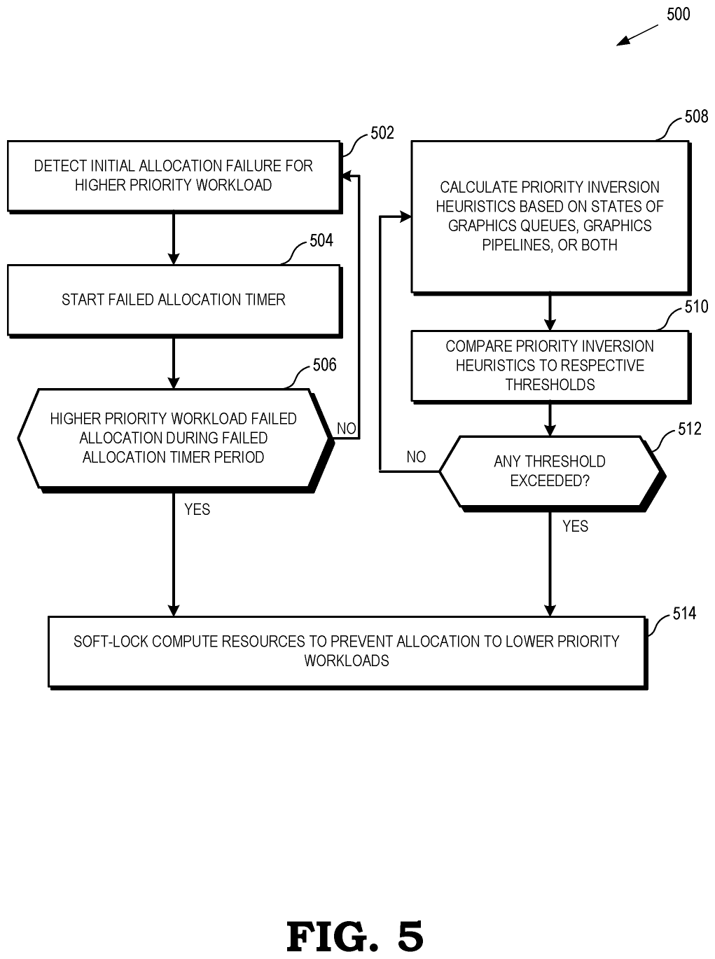

FIG. 5 shows an illustrative process flow for a method 500 of selectively preventing allocation of compute resources to lower priority workloads (e.g., pixel workloads) based on one or more priority inversion heuristics. For example, such prevention is triggered when a higher priority workload (e.g., a geometry workload) fails allocation during a predetermined time period (defined via a failed allocation timer, such as some embodiments of the failed allocation timer 322 of FIG. 3) following an initial failure to allocate compute resources to the higher priority workload, a quantity of incoming higher priority workloads exceeds a threshold (e.g., of the thresholds 324), a quantity of in-flight higher priority workloads exceeds a threshold (e.g., of the thresholds 324), a quantity of RTs of the active workload of the in-flight workloads exceeds a threshold (e.g., of the thresholds 324), or one or more ratios of higher priority workloads to lower priority workloads are lower than their corresponding thresholds (e.g., of the thresholds 324). In some embodiments, the method 500 is performed by executing computer-readable instructions at a parallel processor. In the present example, the method 500 is described in the context of an embodiment of the parallel processor 100 of FIG. 1, and like elements are referred to using like reference numerals. In some embodiments, the method 500 corresponds to an embodiment of blocks 402, 404, 406, and 410 of the method 400 of FIG. 4.

At block 502, the resource allocator 108 detects an initial allocation failure for a higher priority workload. In some embodiments, the higher priority workload is a geometry workload, such as a geometry shader or a vertex shader.

At block 504, the resource allocator 108 initiates a failed allocation timer, such as an embodiment of the failed allocation timer 322 of FIG. 3. The resource allocator 108 activates the failed allocation timer 322 responsive to the detection (at block 502) of a failure to allocate compute resources for the higher priority workload. In some embodiments, the initiation of the failed allocation timer 322 by the resource allocator 108 is further in response to the resource allocator 108 detecting that compute resources have been successfully allocated to a lower priority workload during the same allocation period as that in which the higher priority workload failed allocation. Upon activation, the failed allocation timer 322 is configured to expire once a predetermined amount of time has passed (measured, in some instances, by counting clock cycles with the failed allocation timer). The period during which the failed allocation timer 322 is active (prior to expiry) is sometimes referred to herein as the “failed allocation timer period”. The resource allocator 108 monitors the higher priority workload during the failed allocation timer period to determine whether resources are successfully allocated for processing the higher priority workload during the failed allocation timer period (“successful allocation”) or are not successfully allocated for processing the higher priority workload during the failed allocation timer period (“failed allocation”).

At block 506, if the higher priority workload has failed allocation during the failed allocation timer period, the method 500 proceeds to block 514. Otherwise, if the higher priority workload is successfully allocated during the failed allocation timer period, the method 500 returns to block 502 to monitor for initial allocation failures for other higher priority workloads.

In some embodiments, multiple instances of blocks 502, 504, and 506 are performed by the resource allocator 108 in parallel for multiple higher priority workloads. In some embodiments, blocks 508, 510, and 512 are performed in parallel with blocks 502, 504, and 506.

At block 508, the resource allocator 108 calculates or otherwise tracks the values of one or more priority inversion heuristics 110 based on determined states of one or more graphics queues, such as the graphics queue 122, one or more graphics pipelines, such as some embodiments of the graphics pipelines 306 of FIG. 3, or both graphics queues and graphics pipelines. In some embodiments, the priority inversion heuristics 110 include one or more of a quantity of incoming higher priority workloads 312, a quantity of in-flight higher priority workloads 314, a quantity of incoming lower priority workloads 320, a quantity of RTs in the active workload of the in-flight workloads 316, and one or more ratios of lower priority workloads to higher priority workloads 318 (e.g., as described in the example of FIG. 3).

At block 510, the resource allocator 108 compares the calculated priority inversion heuristics 110 to respective thresholds of the thresholds 324. At block 512, if any priority inversion heuristic exceeds or is otherwise outside of the range defined by its corresponding threshold of the thresholds 324, the method 500 proceeds to block 514. Otherwise, the method returns to block 508 to recalculate the priority inversion heuristics 110 (such that calculation of the priority inversion heuristics 110 is repeated over time, in some cases periodically).

At block 514, in response to determining either that a higher priority workload failed allocation during a corresponding failed allocation timer period or that a priority inversion heuristic 110 has exceeded its corresponding threshold of the thresholds 324 or otherwise gone outside of the range defined by its corresponding threshold, the resource allocator 108 soft-locks all or a subset of computing resources of the parallel processor (e.g., compute units 120 of the shader engines 118) from being allocated to lower priority workloads. For example, the resource allocator 108 activates one or more soft-lock signals (such as an embodiment of the soft-lock signals 326) to initiate a soft-lock of one or more compute resources of the system, preventing such compute resources from being allocated to processing lower priority workloads.

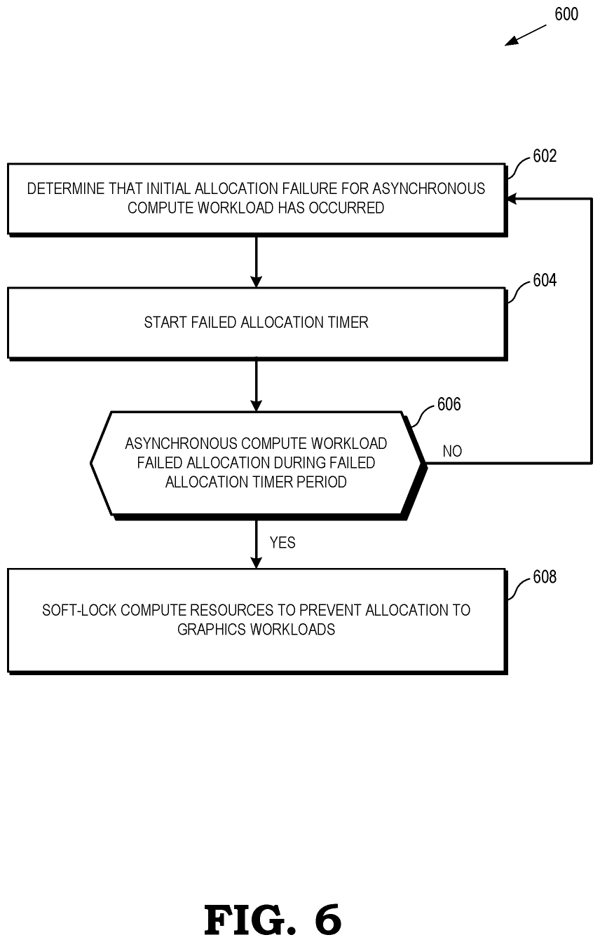

FIG. 6 shows an illustrative process flow for a method 600 of selectively preventing allocation of compute resources to lower priority graphics workloads based on a determination that a higher priority asynchronous compute workload continues to fail allocation throughout a predetermined time period immediately following an initial instance in which the asynchronous compute workload fails allocation, which is indicative of priority inversion between higher priority asynchronous compute workloads and lower priority graphics workloads. In some embodiments, the method 600 is performed by executing computer-readable instructions at a parallel processor. In the present example, the method 600 is described in the context of an embodiment of the parallel processor 100 of FIG. 1, and like elements are referred to using like reference numerals. In some embodiments, the method 600 corresponds to an embodiment of blocks 402, 404, 406, and 410 of the method 400 of FIG. 4.

At block 602, the resource allocator 108 detects an initial allocation failure for a higher priority asynchronous compute workload. At block 604, the resource allocator 108 starts a failed allocation timer, such as an embodiment of the failed allocation timer 322 of FIG. 3. The resource allocator 108 activates the failed allocation timer 322 responsive to the detection (at block 602) of a failure to allocate compute resources for the higher priority asynchronous compute workload. In some embodiments, the initiation of the failed allocation timer 322 by the resource allocator 108 is further in response to the resource allocator 108 detecting that compute resources have been successfully allocated to a lower priority graphics workload during the same allocation period as that in which the higher priority asynchronous compute workload failed allocation. Upon activation, the failed allocation timer 322 is configured to expire once a predetermined amount of time has passed (measured, in some instances, by counting clock cycles with the failed allocation timer). The period during which the failed allocation timer 322 is active (prior to expiry) is sometimes referred to herein as the “failed allocation timer period”. The resource allocator 108 monitors the higher priority asynchronous compute workload during the failed allocation timer period to determine whether resources are successfully allocated for processing the higher priority asynchronous compute workload during the failed allocation timer period (“successful allocation”) or are not successfully allocated for processing the higher priority asynchronous compute workload during the failed allocation timer period (“failed allocation”).

At block 606, if the higher priority asynchronous compute workload has failed allocation during the failed allocation timer period, the method 600 proceeds to block 608. Otherwise, if the higher priority asynchronous compute workload is successfully allocated during the failed allocation timer period, the method 600 returns to block 602 to monitor for initial allocation failures for other higher priority asynchronous compute workloads.

At block 608, the resource allocator 108 soft-locks all or a subset of computing resources of the parallel processor (e.g., compute units 120 of the shader engines 118) from being allocated to lower priority graphics workloads. For example, the resource allocator 108 activates one or more soft-lock signals (such as an embodiment of the soft-lock signals 326) to initiate a soft-lock of one or more compute resources of the system, preventing such compute resources from being allocated to processing lower priority graphics workloads.

While the present example is provided in the context of a scenario in which graphics workloads are lower priority than asynchronous compute workloads, it is possible for graphics workloads to instead be indicated as higher priority than asynchronous compute workloads. For example, alternative embodiments of the method 600 are implemented when graphics workloads are indicated as higher priority than asynchronous compute workloads, in which case the roles of the asynchronous compute workloads and those of the graphics workloads in the method 600 are switched. For example, in some such alternative embodiments of the method 600, determination of an initial failed allocation of a graphics workload initiates the failed allocation timer at block 602, failure of the graphics workload to be allocated during the failed allocation timer period is determined at block 606, and allocation of compute resources to asynchronous compute workloads is prevented at block 608.

In some embodiments, the apparatus and techniques described above are implemented in a system including one or more integrated circuit (IC) devices (also referred to as integrated circuit packages or microchips), such as the parallel processor described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
calculating at least one priority inversion heuristic indicative of priority inversion between higher priority workloads and lower priority workloads of a parallel processor; and
selectively preventing allocation of at least one compute resource of the parallel processor for processing the lower priority workloads based on the at least one priority inversion heuristic.

2. The method of claim 1, further comprising:
responsive to a release condition, allowing allocation of the at least one compute resource for processing the lower priority workloads, wherein the release condition includes at least one of expiry of a timer, a reset of the parallel processor, or a quantity of the higher priority workloads being below a threshold.

3. The method of claim 1, wherein the priority inversion heuristics include at least one of a quantity of incoming higher priority workloads in a queue of the parallel processor, a quantity of in-flight higher priority workloads in at least one pipeline of the parallel processor, a quantity of incoming lower priority workloads in the at least one pipeline, a quantity of render targets of the in-flight higher priority workloads and the incoming lower priority workloads, and one or more ratios of at least a subset of the lower priority workloads to at least a subset of the higher priority workloads.

4. The method of claim 1, further comprising:
initiating a timer responsive to determining that allocation for a higher priority workload has failed, wherein selectively preventing allocation of the at least one compute resource comprises:
selectively preventing, responsive to determining that allocation for the higher priority workload is unsuccessful throughout a timer period between initiation of the timer and expiry of the timer, allocation of the at least one compute resource of the parallel processor for processing the lower priority workloads.

5. The method of claim 4, wherein selectively preventing allocation of the at least one compute resource is further responsive to successful allocation for at least one lower priority workload.

6. The method of claim 1, wherein the higher priority workloads are geometry workloads and the lower priority workloads are pixel workloads.

7. The method of claim 1, wherein the higher priority workloads are asynchronous compute workloads and the lower priority workloads are graphics workloads.

8. A parallel processor comprising:
a graphics engine configured to receive graphics workloads via a graphics queue and to implement at least one graphics pipeline for processing the graphics workloads;
a resource allocator configured to:
calculate at least one priority inversion heuristic based on graphics workloads in at least one of the graphics queue or the at least one graphics pipeline, the at least one priority inversion heuristic indicating priority inversion between higher priority workloads and lower priority workloads of the graphics workloads; and
selectively prevent allocation of at least one compute resource to the lower priority workloads of the graphics workloads based on the at least one priority inversion heuristic.

9. The parallel processor of claim 8, wherein the higher priority workloads are geometry workloads and the lower priority workloads are pixel workloads.

10. The parallel processor of claim 8, further comprising:
a shader engine comprising at least one compute unit, wherein the at least one compute resource comprises the at least one compute unit.

11. The parallel processor of claim 8, wherein the priority inversion heuristics include at least one of a quantity of incoming higher priority workloads in the graphics queue, a quantity of in-flight higher priority workloads in the at least one graphics pipeline, a quantity of incoming lower priority workloads in the at least one graphics pipeline, a quantity of render targets of the in-flight higher priority workloads and the incoming lower priority workloads, and one or more ratios of at least a subset of the lower priority workloads to at least a subset of the higher priority workloads.

12. The parallel processor of claim 8, wherein the resource allocator is further configured to allow, responsive to a release condition, allocation of the at least one compute resource for processing the lower priority workloads, wherein the release condition includes at least one of expiry of a timer, a reset of the parallel processor, or a quantity of the higher priority workloads being below a threshold.

13. The parallel processor of claim 8, wherein the resource allocator is further configured to:
initiate a timer responsive to determining that allocation for a higher priority workload has failed, wherein the resource allocator is configured to selectively prevent allocation of the at least one compute resource responsive to determining that allocation for the higher priority workload is unsuccessful throughout a timer period between initiation of the timer and expiry of the timer.

14. The parallel processor of claim 8, wherein the resource allocator is further configured to prevent allocation of the at least one compute resource responsive to determining that the at least one priority inversion heuristic exceeds a corresponding threshold.

15. The parallel processor of claim 14, wherein the resource allocator is further configured to:
allow allocation of the at least one compute resource responsive to determining that there are less than a predetermined quantity of lower priority workloads in the graphics queue, regardless of whether the at least one priority inversion heuristic exceeds the corresponding threshold.

16. A resource allocator of a parallel processor, the resource allocator being configured to:
calculate at least one priority inversion heuristic based on workloads in a queue, in at least one pipeline, or both, the at least one priority inversion heuristic indicating priority inversion between higher priority workloads and lower priority workloads of the workloads; and
selectively soft-lock at least one compute resource to temporarily prevent the at least one computing resource from being allocated for processing the lower priority workloads of the workloads based on the at least one priority inversion heuristic.

17. The resource allocator of claim 16, wherein the priority inversion heuristics include at least one of a quantity of incoming higher priority workloads in a queue, a quantity of in-flight higher priority workloads in the at least one pipeline, a quantity of incoming lower priority workloads in the at least one pipeline, a quantity of render targets of the in-flight higher priority workloads and the incoming lower priority workloads, and one or more ratios of at least a subset of the lower priority workloads to at least a subset of the higher priority workloads.

18. The resource allocator of claim 16, wherein the resource allocator is further configured to:
initiate a timer responsive to determining that allocation for a higher priority workload has failed, wherein the resource allocator is configured to selectively and temporarily soft-lock the at least one compute resource responsive to determining that allocation for the higher priority workload is unsuccessful throughout a timer period between initiation of the timer and expiry of the timer.

19. The resource allocator of claim 18, wherein the higher priority workloads are geometry workloads and the lower priority workloads are pixel workloads.

20. The resource allocator of claim 18, wherein the higher priority workloads are asynchronous compute workloads and the lower priority workloads are graphics workloads.
